(19) United States
(12) Patent Application Publication
(10) Pub. No.: US 2005/0144378 A1
(43) Pub. Date: Jun. 30, 2005

(54) Method and system to save historical hard disk performance data

(76) Inventor: Andrew S. Grover, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/749,815

(22) Filed: Dec. 30, 2003

(51) Int. Cl. G06F 12/00

(52) U.S. Cl. 711/113; 711/112

(57) ABSTRACT

Method and system to save historical hard disk performance data are described. In one embodiment, the method and system include storing historical hard disk performance data on a non-volatile memory unit of a system; the data being available on the memory unit after the system has been rebooted. In one embodiment, the non-volatile memory unit is a cache of the hard disk. Furthermore, the historical performance data may be used to implement a power management policy of the hard disk.

### NOTIC OF RELATED APPLICATIONS

This application is related to copending patent application titled METHOD AND APPARATUS TO SPIN UP A DISK DRIVE PRIOR TO A DISK DRIVE DATA EXCHANGE REQUEST, patent application Ser. No. ______ filed Dec. 30, 2003 (Attorney Docket No. 42.P18168) copending patent application titled METHOD AND SYSTEM TO ADJUST NON-VOLATILE CACHE ASSOCIATIVITY, patent application Ser. No. ______ filed Dec. 30, 2003 (Attorney Docket No. 42.P18166), and copending patent application titled METHOD AND SYSTEM TO CHANGE A POWER STATE OF A HARD DRIVE, patent application Ser. No. ______ filed Dec. 30, 2003 (Attorney Docket No. 42.P18169).

### FIELD OF INVENTION

The field of invention relates generally to data processing; and, more specifically, to a method and system to save historical hard disk performance data.

### BACKGROUND

A hard disk may be provided with a cache for the hard disk, typically found in random access memory (RAM), to cache data that has been read from the hard disk. However, because the hard disk cache is located in the RAM, data which is to be written to the hard disk is unable to be cached in the cache of the hard disk, because if the computer system were to fail the data to be written to the hard disk would be lost due to the loss of power to the RAM.

In addition, for mobile computers, repeatedly accessing the hard disk is a power consuming activity that involves a power management policy that attempts to reduce the frequency of spinning up the hard disk and the continued use of the hard disk. The more information the disk power management policy includes on how the system has behaved historically, the more likely this system is to improve disk management strategy. For example, the power management policy may be further improved using historical hard disk data about events that resulted in spinning down the hard disk and how long the hard disk remained spun down. Losing the data because of a reboot, or having to access the hard disk for the information and consume additional power in the process, are both less desirable solutions.

### BRIEF DESCRIPTION OF THE DRAWINGS

FIG. 1 presents a flow diagram describing the processes of saving historical hard disk performance data according to one embodiment.

FIG. 2 presents a diagram of a system to save historical hard disk performance data according to one embodiment.

FIG. 3 presents a diagram of a non-volatile memory unit used as a cache according to one embodiment.

### DETAILED DESCRIPTION

A method and system to save historical hard disk performance data are described. In one embodiment, the method and system include storing historical hard disk performance data on a non-volatile memory unit of a system; the data being available on the memory unit after the system has been rebooted. In one embodiment, the non-volatile memory unit is a cache of the hard disk. Furthermore, the historical performance data may be used to implement a power management policy of the hard disk.

In the following description, numerous specific details are set forth. However, it is understood that embodiments may be practiced without these specific details. In other instances, well-known circuits, structures and techniques have not been shown in detail in order not to obscure the understanding of this description.

Reference throughout this specification to “one embodiment” or “an embodiment” indicate that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. In addition, as described herein, a trusted platform, components, units, or subunits thereof, are interchangeably referenced as a protected or secured.

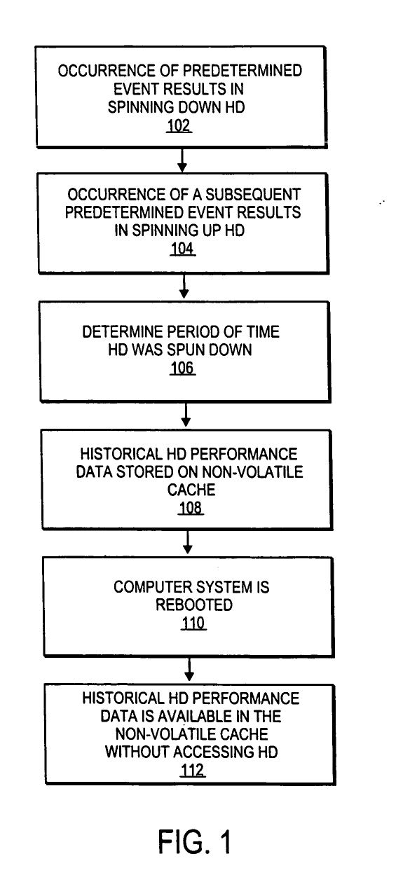

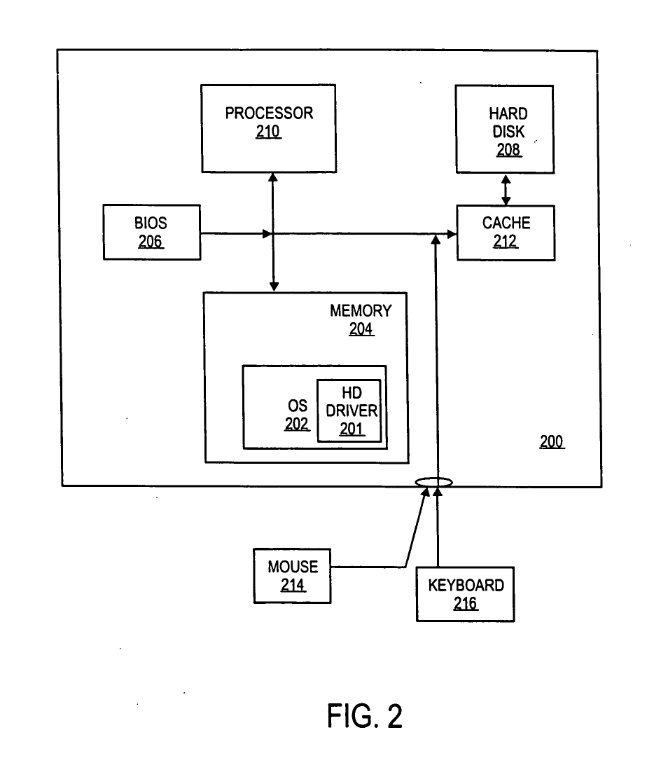

FIG. 1 presents a flow diagram describing the processes of storing historical hard disk performance data on a non-volatile memory unit of a system according to one embodiment. The flow diagram is described with reference to the computer system 200 illustrated in the diagram of FIG. 2.

In process 102, the occurrence of a predetermined event is detected within the computer system 200 that results in spinning down the hard disk (HD). As referenced herein, the HD includes a primary storage medium of the system. In one embodiment, the occurrence of the predetermined event is detected by a HD driver 201 of the operating system 202 within the system, shown stored in memory 204 of the system. In alternative embodiments, alternative units may be used to detect the occurrence of the predetermined event that results in spinning down the HD, such as the Basic Input Output System (BIOS) 206. In one embodiment, in response to detecting the occurrence of the predetermined event, an interrupt is transmitted to the processor 210 of the system 200. In response to the interrupt, the processor signals the operating system (or an alternative unit within the system 200, such as the driver of the hard disk) to spin down or deactivate the hard disk 208.

In one embodiment, the predetermined event includes a predetermined period of time elapsing without a request to write and/or a request to read data to/or from the HD. In an alternative embodiment, the predetermined event may include a predetermined period of time elapsing without the detection of a user of system 200 being present. For example, a predetermined period of time may elapse without detecting movement of an input device, such as a mouse 214, a trackball, or other input devices. In addition, the presence of the computer user may be detected by detecting a key on the keyboard 216 being activated or pressed down. In yet another alternative embodiment, the presence of the computer user may be detected by a camera (not shown) of the computer system 200. In alternative embodiments, other types of techniques may be used to detect the presence of a computer user. Also, other predetermined events may also result in spinning down the HD.

In process 104, in response to a subsequent predetermined event, the HD 208 is activated by spinning up the HD 208. For example, a request is received to write and/or read data to/or from the HD 208. In one embodiment, an interrupt is transmitted to the processor 210 of the system 200. In response to the interrupt, the processor signals the operating system (or an alternative unit within the system 200, such as the driver of the hard disk) to spin up or activate the hard disk 208.

In process 106, the period of time the HD 208 was spun down, since the predetermined event detected in process 102, is determined. In one embodiment, the driver 201 determines the period of the HD 208 was spun down, since the predetermined event detected in process 102.

In process 108, the predetermined event detected in process 102 and the respective period of time the HD remained spun down in response to the predetermined event (herein referenced as “historical HD performance data”) are recorded in a non-volatile memory unit 212 of the system 200. In alternative embodiments, the historical HD performance data may include alternative combinations of the data, and/or other data related to the spinning down and up of the HD. In addition, in an alternative embodiment, the predetermined event detected in process 102 may be recorded in the non-volatile memory unit 212 of the system 200 prior to the spinning up of the HD and/or prior to determining the period of time the HD 208 was spun down, since the predetermined event detected in process 102.

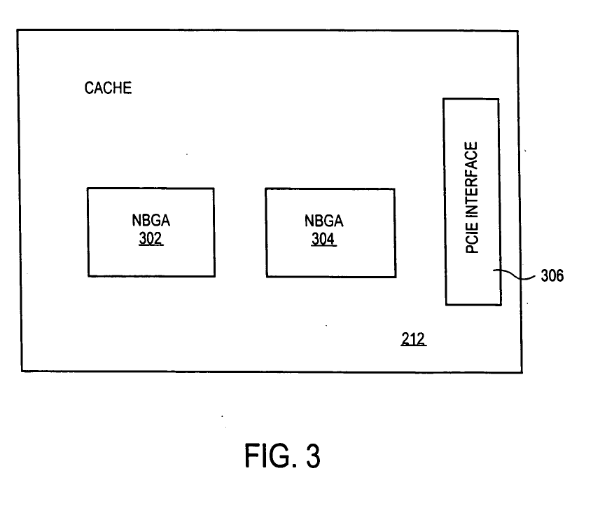

In one embodiment, the non-volatile memory unit 212 is a cache of the HD 208 (also referenced herein as cache 212). FIG. 3 illustrates the non-volatile memory unit according to one embodiment. In one embodiment, the cache 212 of the hard disk 208 is a thin film electronics memory made of Ferroelectric polymer with multiple layers stacked on top of standard complimentary metal oxide semiconductor (CMOS). In one embodiment, the cache 212 of the hard disk 208 has a 512 megabyte (mb) capacity. In one embodiment, the cache comprises two 256 mb microBall Grid Arrays (BGA) 302, 304. In one embodiment, the cache 212 includes a form factor of a Mini Peripheral Component Interconnect Express (PCIE) card, and also includes PCIE interface 306. In alternative embodiments, the cache 212 may be made of alternative materials, consist of alternative capacity, an alternative form factor, and/or and alternative interface.

In process 110, the computer system is rebooted, which includes at least temporarily turning off the power to the computer system, and thereafter restoring the power to the computer and reloading the operating system. In process 112, after the computer system has been rebooted, the historical HD performance data in the cache 212 is available to be accessed from the cache 212 without having to spinup the HD.

As a result, the historical HD performance data is available across reboots of the system for providing a power management policy for the HD. The power management policy may determine, based at least in part on the historical HD performance data, when to spin down the HD in response to select events. By storing the historical HD performance data in the nonvolatile cache 212, the HD does not have to be spun up to access the data, and the data will be saved across rebooting of the system.

The processes described above can be stored in the memory of a computer system as a set of computer-readable instructions to be executed. In addition, the instructions to perform the processes described above could alternatively be stored on other forms of machine-readable media, including magnetic and optical disks. For example, the processes described could be stored on machine-readable media, such as magnetic disks or optical disks, which are accessible via a hard disk (or computer-readable medium drive). Further, the instructions can be downloaded into a computing device over a data network in a form of compiled and linked version.

Alternatively, the logic to perform the processes as discussed above could be implemented in additional computer and/or machine readable media, such as discrete hardware components as large-scale integrated circuits (LSI's), application-specific integrated circuits (ASIC's), firmware such as electrically erasable programmable read-only memory (EEPROM's); and electrical, optical, acoustical and other forms of propagated signals (e.g., carrier waves, infrared signals, digital signals, etc.); etc.

In the foregoing specification, the invention has been described with reference to specific exemplary embodiments thereof. It will, however, be evident that various modifications and changes may made thereto without departing from the broader spirit and scope of the invention as set forth in the appended claims. For example, the non-volatile memory unit, as described herein, may be used as a cache for other components within a system, other than the HD. The specification and drawings are, accordingly, to be regarded in an illustrative rather than a restrictive sense.

1. A method comprising:
storing historical hard disk performance data on a non-volatile memory unit of a system, the data being available on the memory unit after the system has been rebooted.

2. The method of claim 1, wherein the non-volatile memory unit is a cache for the hard disk.

3. The method of claim 2, wherein the non-volatile memory unit includes a form factor of a Mini Peripheral Component Interconnect Express card.

4. The method of claim 1, wherein the non-volatile memory unit includes a Peripheral Component Interconnect Express interface.

5. The method of claim 1, wherein the non-volatile memory unit consists of a thin film electronics memory.

6. The method of claim 1, further including using the historical hard disk performance data to implement a power management policy of the hard disk.

7. The method of claim 1, wherein the historical hard disk performance data consists of data identifying events the produced a spin-down of the hard disk and a period of time thereafter before the hard disk was spun up.

8. A machine readable medium having stored thereon a set of instructions which when executed cause a system to perform a method comprising of:
storing historical hard disk performance data on a non-volatile memory unit of a system, the data being available on the memory unit after the system has been rebooted.

9. The machine readable medium of claim 8, wherein the non-volatile memory unit is a cache for the hard disk.

10. The machine readable medium of claim 9, wherein the non-volatile memory unit includes a form factor of a Mini Peripheral Component Interconnect Express card.

11. The machine readable medium of claim 8, wherein the non-volatile memory unit includes a Peripheral Component Interconnect Express interface.

12. The machine readable medium of claim 8, wherein the non-volatile memory unit consists of a thin film electronics memory.

13. The machine readable medium of claim 8, wherein the historical hard disk performance data consists of data identifying events the produced a spin-down of the hard disk and a period of time thereafter before the hard disk was spun up.

14. A system comprising of:
a processor;
a non-volatile cache coupled to the processor; and
a machine readable medium having stored thereon a set of instructions which when executed cause the system to perform a method comprising of:
storing historical hard disk performance data on the non-volatile cache of a system, the data being available on the non-volatile cache after the system has been rebooted.

15. The system of claim 8, wherein the non-volatile cache is a cache for the hard disk.

16. The system of claim 14, wherein the non-volatile cache includes a form factor of a Mini Peripheral Component Interconnect Express card.

17. The system of claim 8, wherein the non-volatile cache includes a Peripheral Component Interconnect Express interface.

18. The system of claim 8, wherein the non-volatile cache consists of a thin film electronics memory.

19. The system of claim 8, wherein the historical hard disk performance data consists of data identifying events the produced a spin-down of the hard disk and a period of time thereafter before the hard disk was spun up.
